(19) United States
(12) Patent Application Publication
(10) Pub. No.: US 2006/0087727 A1
(43) Pub. Date: Apr. 27, 2006

(54) Apparatus, system and method for selective photobleaching, imaging and confocal microscopy

(76) Inventor: Jeffrey Brooker, Oak Hill, VA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/969,357

(22) Filed: Oct. 21, 2004

(51) Int. Cl. G02B 21/00

(52) U.S. Cl. 359/368; 359/234

(57) ABSTRACT

A module, an attachment for a microscope, a microscope, an optical path, and a method which allow for the rapid exchange of an aperture and a spinning disk in a light path for the purpose of, for example, selectively photobleaching sections of a specimen, imaging of the specimen and confocal microscopy, are disclosed. An ability to introduce light to photobleach a section of a specimen without the need for a laser or a second illumination path in the optical system is achieved. The specimen and the area to be bleached are allowed to be viewed in a non damaging wavelength for registration purposes. Photobleaching light can be introduced to a specimen and the objective through the exact same light path as that used for imaging or confocal microscopy. The size, shape and position of the area that is to be bleached can be mechanically adjusted while viewing the specimen. The use of the arc lamp as the source for the illumination is allowed and has the advantage of being able to select the wavelength and the bandwidth of the illumination used for the photobleaching.

### BACKGROUND OF THE INVENTION

1. Field of the Invention

The present invention is directed to a module, an attachment for a microscope, a microscope, an optical system, and a method, which allow for exchange of an aperture and a spinning disk in a light path for the purpose of, for example, selectively photobleaching sections of a specimen, imaging of the specimen, and confocal microscopy.

2. Discussion of the Background

Confocal microscopy is established as a technique used in a great number of laboratories. Confocal optical microscopes, and particularly scanning confocal optical microscopes, are known for having an extremely short depth of focus and improved transverse resolution. A confocal optical microscope includes a light source to illuminate an object as well as a means to view the illuminated object.

Also known in the art is a confocal attachment to a standard microscope which allows confocal microscopy.

A simplified confocal attachment has been developed and is described in U.S. Pat. No. 6,147,798. As shown in FIG. 4, the attachment 200 for a microscope 50 to be coupled to an optical coupling tube 85 of the microscope includes a light source 70 generating a quasi-collimated light output. In the attachment, elements 80 and 120 are provided for reflecting the light output from the light source towards a specimen 10 in the microscope 50. Further, elements are provided for propagating a reflection of the light output from the light source from the specimen to a viewing point 100. The elements for achieving the reflecting and the elements for achieving the propagating may each include a spinning Nipkow disk 60 and a dichroic mirror 80. The quasi-collimated light output from the light source directly impinges on the Nipkow disk, i.e. without being focused on the Nipkow disk and without passing through a lens. A right angle mirror 120 can also be positioned as one of the elements for achieving the reflecting and the propagating.

One of the known uses of confocal microscopy is in Fluorescence Recovery After Photobleaching (FRAP) and Fluorescence Loss in Photobleaching (FLIP) experiments. In particular, FRAP allows the measurement of the recovery of fluorescence in a defined region of a sample after a bleaching event. The return of fluorescence is generated by the migration of unbleached fluorophores from the surrounding into the bleached area. FRAP is used to measure the dynamics of 2D or 3D molecular mobility e.g. diffusion, transport or any other kind of movement of fluorescently labeled molecules in membranes or in living cells.

On the other hand, FLIP allows the measurement of the decrease/disappearance of fluorescence in a defined region adjacent to a bleached region. Like FRAP, FLIP is used to measure the dynamics of molecular mobility in membranes or in living cells.

As shown in FIGS. 5a-5c, during a FRAP experiment, an area, for example a fluorescently labeled cell surface, is imaged with low laser intensity. Subsequently, an excitation light pulse of high intensity is used to strongly bleach a defined region, e.g. a diffraction-limited spot, small bleach-ROI, or linear pattern of parallel stripes within the field of view. Finally, the time course of recovery in the bleached region is monitored using a dimmed excitation laser beam. As a result, FRAP indicates any kind of movement (passive e.g. diffusion or active e.g. transport) of fluorescent molecules. The recovery time (half-recovery time) indicates the speed of this mobility, e.g. diffusion time.

The currently available methods of FRAP/FLIP utilize a laser. In one method, a laser is introduced into the microscope through the fluorescence path. The beam is expanded and contracted by a variable beam expander. It is moved in the XY direction in the plane of the sample by moving the input of the laser beam into the scope. There is a shutter in front of the laser which allows the duration of the pulse to be controlled by a computer. In another method, a laser scanning microscope is used. The excitation laser is turned to full power and then the scanning is concentrated into a small area using the scanning mirrors. This technique allows the area which is to be bleached to be defined within the field of the objective. Due to the scanning mirrors, any shape can be generated and selectively beached by the laser beam.

A major draw back of both of these methods is that the wavelength of light used for photobleaching is limited to the emission wavelength of the laser.

Another drawback of conventional FRAP/FLIP methods is that the photobleaching light is introduced along a different path from that used for imaging and/or confocal observation of the specimen.

### SUMMARY OF THE INVENTION

The invention provides an ability to introduce light to photobleach a section of a specimen without the need for a laser or a second illumination path in the optical system. It also allows the specimen to be viewed and the area to be bleached to be viewed in a non damaging wavelength for registration purposes. The size, shape and position of the area that is to be bleached can be mechanically adjusted while viewing the specimen. The use of a broad spectrum light source, such as an arc lamp, as the source for the illumination provides the advantage of being able to select the wavelength and the bandwidth of the illumination to be used for the photobleaching.

An embodiment of the invention provides a module comprising a light path, an aperture that can be moved in and out of the light path, and a spinning disk that, likewise, can be moved in and out of the light path. When the aperture is moved into the light path, the aperture is placed in the same plane as the plane of the spinning disk when the spinning disk is moved into the light path.

Another embodiment provides an attachment for a microscope that has focusing optics for focusing a light onto a specimen and for returning a focused image of the specimen. The attachment comprises a light source outputting a light along a light path, a spinning disk that can be moved in and out of the light path so that, when the disk is positioned for the light to pass therethrough, the disk is at a conjugate focal plane of the focusing optics. The attachment further comprises an aperture that can be moved in and out of the light path so that, when the aperture is positioned for the light to pass therethrough, the aperture is at the conjugate focal plane of the focusing optics.

Yet another embodiments provides a microscope comprising focusing optics that focus a light onto a specimen and return a focused image of the specimen, a light source outputting a light along a light path, a spinning disk that can be moved in and out of the light path so that, when the disk is positioned for the light to pass therethrough, the disk is at a conjugate focal plane of the focusing optics, and an aperture that can be moved in and out of the light path so that, when the aperture is positioned for the light to pass therethrough, the aperture is at the conjugate focal plane of the focusing optics.

Yet another embodiment provides an optical path comprising focusing optics positioned to focus a light onto a specimen and return a focused image of the specimen, a spinning disk that can be moved in and out of the light path so that, when the disk is positioned for the light to pass therethrough, the disk is at a conjugate focal plane of the focusing optics, and an aperture that can be moved in and out of the light so that when the aperture is positioned for the light to pass therethrough, the aperture is in a conjugate focal plane of the focusing optics.

Yet another embodiment provides a method for photobleaching a specimen and performing confocal microscopy, using a microscope having focusing optics that focus a light onto a specimen and return a focused image of the specimen. The method comprises selectively positioning an aperture at a conjugate focal plane of the focusing optics for the light to pass therethrough and to image the aperture onto the specimen, exposing the specimen to light sufficient to cause photobleaching, and selectively positioning a spinning disk along the light path at the conjugate focal plane of the focusing optics for the light to pass therethrough to perform confocal microscopy.

A still further embodiment of the invention provides a module comprising a light path, two prisms positioned in the light path, and a spinning disk which can be moved in and out of the light path with respect to at least one of the two first prisms, so that, when the spinning disk is moved into the light path, the spinning disk is positioned between the two prisms.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 shows an implementation of an embodiment of the present invention.

FIG. 2 shows a top view of a module according to an exemplary implementation of the present invention.

FIGS. 3a-3c show a module according to an exemplary implementation of the present invention. FIG. 3a shows a top view. FIG. 3b is a sectional view of a module shown in FIG. 3a along line I-I. FIG. 3b shows a detailed view of a portion 38 of the module shown in FIG. 3b.

FIG. 4 shows another background confocal attachment for a standard microscope.

FIGS. 5a-5c show a background FRAP experiment.

### DESCRIPTION OF THE EMBODIMENTS OF THE INVENTION

Referring now to the drawings, wherein like reference numerals designate identical or corresponding parts throughout the several views embodiments of the present invention are shown in schematic detail.

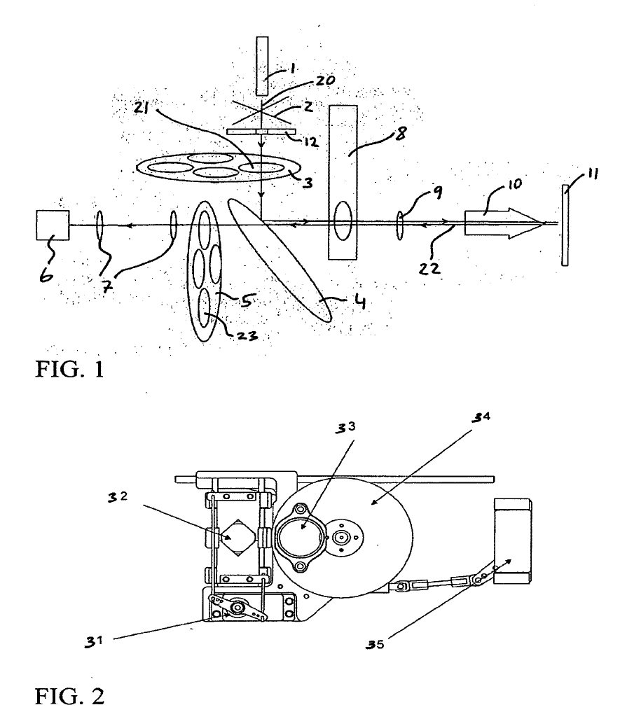

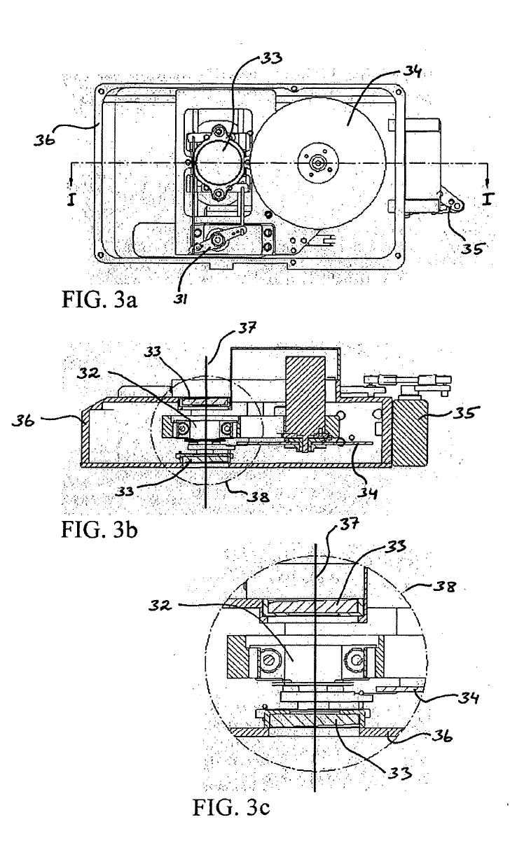

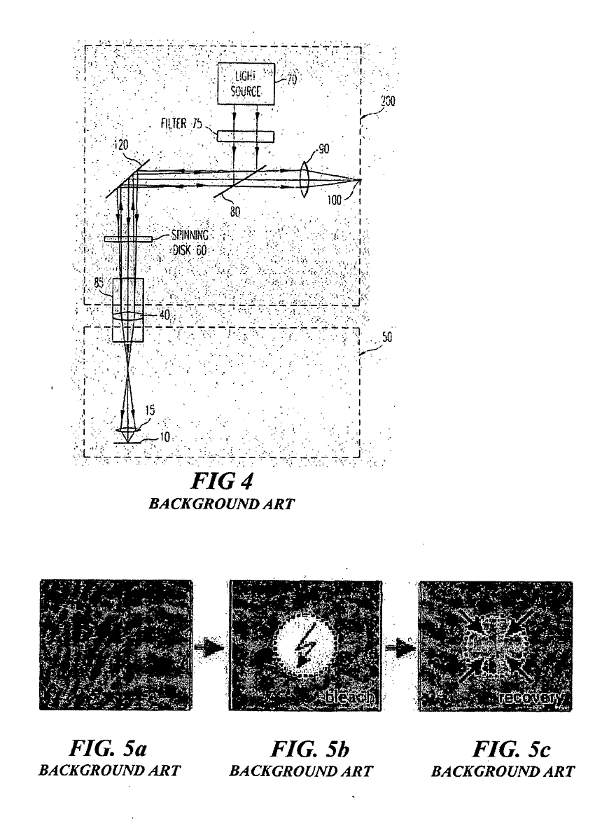

FIG. 1 illustrates a light path of a microscope, or of an attachment to a microscope, in accordance with an embodiment of the present invention. The light path is an exemplary schematic showing how photobleaching light can be introduced to a specimen and the objective through the exact same light path as that used for imaging and/or confocal microscopy. The illumination of the specimen 11 starts with the introduction of multispectral light via, for example, a liquid light guide 1. The input light 20 may be shuttered by a solenoid driven shutter 2. The intensity of the input light can also be controlled by an iris 12. The beam of light then passes through the excitation filter 21. These filters are mounted in a wheel 3, which allows the user to select from eight different positions (only four positions are shown for simplicity). In the case where broadband illumination is desired the user can omit a filter from the wheel 3. The main dichroic wheel 4 reflects the excitation wavelength and reflects the light toward a module 8 having an aperture which can be moved in and out of the light path, and a spinning disk which, likewise, can be moved in and out of the light path. Both the spinning disk and the aperture are placed in the conjugate focal plane when moved into the light path. (An exemplary implementation of the components in module 8 is illustrated in FIGS. 2 and 3a-3c, which are described below.)

The light travels through module 8 (which contains an aperture and a spinning disk) and passes through the tube lens 9 and then through the objective 10 to the specimen 11. The combination of tube lens 9 and objective 10 comprises the focusing optics that focus the illumination light on the specimen 11. When the aperture of module 8 is placed in the light path, the size of the opening of the aperture may be varied to control the area of the specimen 11 illuminated. The emission light 22 from the specimen, which can be reflected light or specimen fluorescence, passes through, and is focused by, objective 10 and tube lens 9, passes back through the module 8 (it is to be noted that in a wide-field mode, the aperture is opened or moved out of the light path to provide a clear viewing field), passes through the dichroic mirrors (not shown) mounted in the wheel 4 and then is filtered by the emission filter 23 mounted in wheel 5 before being reformed and relayed by the lens set 7 and viewed by the detector 6.

The light path for confocal microscopy is the same as described above for photobleaching and imaging. That is, for confocal microscopy the spinning disk of module 8 is placed in the light path rather than the aperture.

FIGS. 2 and 3a-3c illustrate an exemplary implementation of components in module 8 of FIG. 1. FIG. 2 shows an aperture 32 mounted co-planer to the spinning disk 34. The aperture can be opened and closed by actuating the servo motor 31. This apparatus is contained within a housing 36 having a light path 37 therethrough, as shown in FIGS. 3b and 3c. The wedge prisms 33 may be mounted in either side of the housing 36 in the light path 37 through the housing 36. The disk 34 and the aperture 32 can be moved together in the same plane by servo 35 (FIG. 2 illustrates spinning disk 33 positioned in the light path 37, while FIGS. 3a-3c illustrate aperture 32 positioned in the light path 37).

When in confocal mode, the disk 34 is powered on and is spinning at a high rate of speed and is positioned by servo 35 in the light path 37 to be visible through the prisms 33 (see, for example, FIG. 2). When is wide-field mode, the servo 35 moves the aperture 32 into position (see, for example, FIG. 3a) and servo 31 opens the aperture to provide a clear viewing field. When using the device for photobleaching a specimen, the aperture 32 is put between the prisms 33 (see, for example, FIGS. 3a-3c) and the size of the opening of the aperture is opened or closed by servo 31 to the desired size to facilitate photo induced bleaching of the specimen.

In one embodiment, the area of the specimen to be photobleached may be varied by moving the aperture in a plane between prisms 33 by, for example, a servo such as servo 35. This allows the user to move the area to be photobleached with the aperture around the field of the objective without moving the specimen.

Obviously, numerous additional modifications and variations of the present invention are possible in light of the above teachings. For example, the aperture may comprise an iris whose opening is controlled by a servo or manually, or may comprise a mask having selectable openings of varying size therein. Another modification that is within the scope of the invention is the type and/or format of the excitation illumination. An arc lamp with direct optical coupling could be attached to the light path in place of the liquid light guide. Also, the arc lamp may be replaced with a laser to provide the illumination.

Furthermore, while FIGS. 2 and 3a-3c show an implementation of a module where aperture 32 and disk 34 move in the same plane throughout, this is not a requirement as long as the aperture 32 and disk 34 are positioned in the same plane when moved into the light path 37.

It is therefore to be understood that within the scope of the appended claims, the present invention may be practiced otherwise than as specifically described herein.

I claim:

1. A module comprising:
a light path;
an aperture removably positioned with respect to the light path; and
a spinning disk removably positioned with respect to the light path;
wherein:
when the aperture is positioned in the light path, the aperture is in a first plane;
when the spinning disk is positioned in the light path, the spinning disk is in a second plane; and
the first plane and the second plane are coplanar.

2. The module as claimed in claim 1, wherein the aperture has a variable size opening.

3. The module as claimed in claim 2, further comprising a servo which varies the size of the opening of the aperture.

4. The module as claimed in claim 1, wherein the aperture and the spinning disk are essentially co-planar.

5. The module as claimed in claim 1, wherein the aperture and the spinning disk are movable in essentially the same plane.

6. The module as claimed in claim 1, further comprising at least one servo which moves at least one of the spinning disk and the aperture with respect to the light path.

7. The module as claimed in claim 1, further comprising a first prism and a second prism positioned in the light path, wherein at least one of the aperture and the spinning disk is removably positioned between the first prism and the second prism.

8. The module as claimed in claim 7, wherein at least one of the first prism and the second prism comprises a wedge prism positioned in the light path.

9. The module as claimed in claim 7, wherein an axis of at least one of the aperture and the spinning disk is inclined with respect to the light path.

10. The module as claimed in claims 1, wherein the spinning disk comprises a Nipkow spinning disk.

11. An attachment for a microscope, the microscope comprising focusing optics configured to perform at least one of focusing a light onto a specimen and returning a focused image of the specimen, the attachment comprising:
a light source outputting a light along a light path;
a spinning disk removably positioned with respect to the light path so that, when the disk is positioned for the light to pass therethrough, the disk is at a conjugate focal plane of the focusing optics; and
an aperture removably positioned with respect to the light path so that, when the aperture is positioned for the light to pass therethrough, the aperture is at the conjugate focal plane of the focusing optics.

12. The attachment as claimed in claim 11, wherein the aperture has a variable size opening which is imaged onto the specimen when the aperture is positioned for the light to pass therethrough.

13. The attachment as claimed in claim 12, further comprising a first servo which varies the size of the opening of the aperture.

14. The attachment as claimed in claim 11, wherein the aperture and the spinning disk are essentially co-planar.

15. The attachment as claimed in claim 11, wherein the aperture and the spinning disk are movable in essentially the same plane.

16. The attachment as claimed in claim 11, further comprising at least one servo which moves at least one of the spinning disk and the aperture into and/or in the conjugate focal plane of the focusing optics.

17. The attachment as claimed in claim 11, further comprising a first prism and a second prism positioned for the light to pass therethrough, wherein at least one of the aperture and the spinning disk are removably positioned between the first prism and the second prism.

18. The attachment as claimed in claim 17, wherein at least one of the first prism and the second prism comprises a wedge prism positioned for the light to pass therethrough.

19. The attachment as claimed in claim 17, wherein an axis of at least one of the aperture and the disk is inclined with respect to the light path.

20. The attachment as claimed in claims 11, wherein the light facilitates photo induced bleaching of the specimen.

21. The attachment as claimed in claim 20, wherein the aperture is positioned for the light to pass therethrough, and the photo induced bleaching of the specimen is a function of at least one of a size of an opening of the aperture and a position of an axis of the aperture with respect to the light path.

22. The attachment as claimed in claim 11, wherein the light facilitates confocal scanning and/or imaging of the specimen.

23. The attachment as claimed in claim 22, wherein the spinning disk is positioned for the light to pass therethrough.

24. The attachment as claimed in claims 11, wherein the spinning disk comprises a Nipkow spinning disk.

25. The attachment as claimed in claim 11, wherein the light is at least one of a broad-spectrum light, a white light, a laser light, and a quasi-collimated light.

26. The attachment as claimed in claim 11, further comprising at least one excitation filter positioned on the light path between the light source and the aperture, when the aperture is positioned for the light to pass therethrough.

27. The attachment as claimed in claim 26, further comprising at least one emission filter positioned on the light path at an image output side of the spinning disk.

28. The attachment as claimed in claim 11, further comprising a dichroic mirror positioned on the light path to reflect or transmit the light from the light source to at least one of the aperture and the spinning disk when the at least one of the aperture and the spinning disk is positioned for the light to pass therethrough.

29. A microscope comprising:
focusing optics configured to perform at least one of focusing a light onto a specimen and returning a focused image of the specimen;
a light source outputting a light along a light path;
a spinning disk removably positioned with respect to the light path so that, when the disk is positioned for the light to pass therethrough, the disk is at a conjugate focal plane of the focusing optics; and
an aperture removably positioned with respect to the light path so that, when the aperture is positioned for the light to pass therethrough, the aperture is at the conjugate focal plane of the focusing optics.

30. The microscope as claimed in claim 29, wherein the aperture has a variable size opening which is imaged onto the specimen when the aperture is positioned for the light to pass therethrough.

31. The microscope as claimed in claim 30, further comprising a first servo which varies the size of the opening of the aperture.

32. The microscope as claimed in claim 29, wherein the aperture and the spinning disk are essentially co-planar.

33. The microscope as claimed in claim 29, wherein the aperture and the spinning disk are movable in essentially the same plane.

34. The microscope as claimed in claim 29, further comprising at least one servo which moves at least one of the spinning disk and the aperture into and/or in the conjugate focal plane of the focusing optics.

35. The microscope as claimed in claim 29, further comprising a first prism and a second prism positioned for the light to pass therethrough, wherein at least one of the aperture and the spinning disk are removably positioned between the first prism and the second prism.

36. The microscope as claimed in claim 35, wherein at least one of the first prism and the second prism comprises a wedge prism positioned for the light to pass therethrough.

37. The microscope as claimed in claim 35, wherein an axis of at least one of the aperture and the disk is inclined with respect to the light path.

38. The microscope as claimed in claims 29, wherein the light facilitates photo induced bleaching of the specimen.

39. The microscope as claimed in claim 38, wherein the aperture is positioned for the light to pass therethrough, and the photo induced bleaching of the specimen is a function of at least one of a size of an opening of the aperture and a position of an axis of the aperture with respect to the light path.

40. The microscope as claimed in claim 29, wherein the light facilitates confocal scanning and/or imaging of the specimen.

41. The microscope as claimed in claim 40, wherein the spinning disk is positioned for the light to pass therethrough.

42. The microscope as claimed in claims 29, wherein the spinning disk comprises a Nipkow spinning disk.

43. The microscope as claimed in claim 29, wherein the light is at least one of a broad-spectrum light, a white light, a laser light, and a quasi-collimated light.

44. The microscope as claimed in claim 29, further comprising at least one excitation filter positioned on the light path between the light source and the aperture, when the aperture is positioned for the light to pass therethrough.

45. The microscope as claimed in claim 44, further comprising at least one emission filter positioned on the light path at an image output side of the spinning disk.

46. The microscope as claimed in claim 29, further comprising a dichroic mirror positioned on the light path to reflect or transmit the light from the light source to at least one of the aperture and the spinning disk when the at least one of the aperture and the spinning disk is positioned for the light to pass therethrough.

47. An optical system for use in imaging, the system comprising:
focusing optics configured to perform at least one of focusing a light onto a specimen and returning a focused image of the specimen;
a spinning disk removably positioned with respect to the light path so that, when the disk is positioned for the light to pass therethrough, the disk is at a conjugate focal plane of the focusing optics; and
an aperture removably positioned with respect to the light so that when the aperture is poisoned for the light to pass therethrough, the aperture is in a conjugate focal plane of the focusing optics.

48. The optical system as claimed in claim 47, wherein the aperture has a variable size opening which is imaged onto the specimen when the aperture is positioned for the light to pass therethrough.

49. The optical system as claimed in claim 47, further comprising a first prism and a second prism positioned for the light to pass therethrough, wherein at least one of the aperture and the spinning disk is removably positioned between the first prism and the second prism.

50. The optical system as claimed in claim 49, wherein at least one of the first prism and the second prism comprises a wedge prism positioned for the light to pass therethrough.

51. The optical system as claimed in claim 47, wherein the aperture is positioned for the light to pass therethrough, and the amount of light focused onto the specimen is a function of at least one of a size of an opening of the aperture and a position of an axis of the aperture with respect to the light.

52. The optical system as claimed in claims 47, wherein the spinning disk comprises a Nipkow spinning disk.

53. The optical system as claimed in claim 47, wherein the light is at least one of a broad-spectrum light, a white light, a laser light, and a quasi-collimated light.

54. The optical system as claimed in claim 47, further comprising at least one excitation filter positioned at a light input side of the aperture, when the aperture is positioned for the light to pass therethrough.

55. The optical system as claimed in claim 54, further comprising at least one emission filter positioned at an image output side of the spinning disk.

56. The optical system as claimed in claim 47, further comprising a dichroic mirror positioned to reflect or transmit the light to at least one of the aperture and the spinning disk when the at least one of the aperture and the spinning disk is positioned for the light to pass therethrough.

57. A method for photobleaching a specimen and performing confocal microscopy, using a microscope comprising focusing optics configured to perform at least one of focusing a light onto a specimen and returning a focused image of the specimen, the method comprising:
selectively positioning an aperture at a conjugate focal plane of the focusing optics for the light to pass therethrough and to image the aperture onto the specimen; and
selectively positioning a spinning disk along the light path at the conjugate focal plane of the focusing optics for the light to pass therethrough to perform confocal microscopy.

58. The method according to claim 57, wherein the light photobleaches the specimen.

59. The method according to claim 58, where selectively positioning of the aperture further comprises at least one of:
varying the size of the opening of the aperture; and
moving the aperture in the conjugate focal plane.

60. The method as claimed in claim 57, wherein the light facilitates confocal microscopy.

61. The method as claimed in claim 60, wherein the spinning disk comprises a Nipkow spinning disk, and the selectively positioning of the disk comprises positioning the disk for scanning and/or imaging of the specimen.

62. The method as claimed in claim 57, further comprising positioning a first prism and a second prism positioned for the light to pass therethrough, wherein at least one of the aperture and the spinning disk is selectively positioned between the first prism and the second prism.

63. A module comprising:
a light path;
a first prism positioned in the light path;
a second prism positioned in the light path;
a spinning disk removably positioned with respect to the light path, and with respect to al least one of the first prism and the second prism;
wherein the spinning disk is positioned between the prisms when the spinning disk is positioned in the light path.
